(19) United States
(12) Patent Application Publication
(10) Pub. No.: US 2006/0173096 A1
(43) Pub. Date: Aug. 3, 2006

(54) Aqueous ink composition, and ink jet recording method and recorded matter using the same

(75) Inventor: Hitoshi Ota, Nagano (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/338,440

(22) Filed: Jan. 24, 2006

(30) Foreign Application Priority Data
Jan. 24, 2005 (JP) P.2005-015461

(51) Int. Cl. C09D 11/00

(52) U.S. Cl. 523/161; 523/205

(57) ABSTRACT

The present invention provides n aqueous ink composition comprising a coloring component, an acetylene glycol-based surfactant, water, and a urea derivative, wherein the coloring component is a dispersion substance in which a colorant is enclosed with a dispersing polymer thereby being rendered dispersible in water, wherein the dispersing polymer comprises a hydrophobic part and a hydrophilic part, wherein at least a part of the hydrophilic part is a neutralized group obtained by neutralizing an unneutralized group constituting a part of the hydrophilic part, and wherein the neutralized groups are present within an amount range of from 20% to less than 60% in terms of molar ratio based on the sum of the neutralized groups and the unneutralized groups.

### FIELD OF THE INVENTION

The present invention relates to an aqueous ink composition, and an ink jet recording method and recorded matter using the same.

### BACKGROUND OF THE INVENTION

An ink jet recording method executes recording by causing an ink composition to fly as a small droplet and depositing it on a recording medium such as paper. This method is capable of recording a high-quality image with a high resolution at a high speed by a relatively inexpensive apparatus. Properties required for an ink to be employed in this method include a satisfactory fastness, such as a water resistance and a light fastness, of a recorded image, absence of an irregular ink flow or a spreading largely from a deposited ink droplet (hereinafter referred to as “blurring”) regardless of a type of the recording medium, absence of an irregular unevenness in the recording density (hereinafter referred to as “density unevenness”) regardless of a type of the recording medium, absence of ink penetration to the back side of the paper (hereinafter referred to as “strike through”), and a high recording density and a satisfactory recording quality regardless of a type of the recording medium (particularly, absence of blurring, density unevenness and strike through and a high recording density on a plain or recycled paper, and absence of blurring and density unevenness and an excellent gloss on a glossy medium such as a glossy paper or a photo paper).

An ink composition employed in an ink jet recording method is generally constituted of water as a principal component, and a coloring component and a humectant such as glycerin for preventing a nozzle clogging. As the colorant in such ink composition for ink jet recording, various water-soluble dyes are used for the reasons of a high color saturation of the colorant, a wide variety of available colorants, and a high solubility in water.

However, dyes may be inferior in properties such as a light fastness and a water resistance, so that recorded matter recorded with a dye-based ink composition may be inferior in the light fastness and the water resistance. The water resistance is improved by a recording medium exclusive for ink jet recording having an ink absorbing layer, but is still insufficient in a plain paper.

On the other hand, pigments are superior to dyes in the light fastness and the water resistance, and are recently investigated for use as a colorant in the ink composition for ink jet recording, for the purpose of improving the light fastness and the water resistance. In case of employing a pigment, which is generally insoluble in water, in an aqueous ink composition, the pigment has to be mixed with a dispersant such as a water-soluble resin and stably dispersed in water for preparing an ink composition.

For obtaining a stable dispersion of a pigment in an aqueous system, investigations are required for example on the type and particle size of the pigment, the type of a dispersant and dispersing means to be employed, and various dispersing methods and ink jet recording inks have been proposed. For example, an aqueous pigment-based ink in which carbon black is dispersed with a surfactant or a polymer dispersant is already known (Patent Documents 1 and 2). Also an ink composition constituted of water, a styrene-maleic acid copolymer, ε-caprolactam and a pigment has been proposed (Patent Document 3). Also an ink composition containing an aqueous medium, a styrene-maleic acid copolymer, and a copper-phthalocyanine pigment has been proposed (Patent Document 4). Also there has been proposed an aqueous ink using a resin in which 60 mol. % or more of acid groups of a dispersing polymer are neutralized with an alkaline neutralizer (Patent Documents 5 and 6).

Also for improving ejection stability of a pigment-based ink from a thermal ink jet recording head, an ink containing a pigment dispersed with a block copolymer dispersant, ethyleneurea and ethylene glycol has been proposed (Patent Document 7).

Also for the purposes of improving a water resistance and a color development of an ink on a recording medium, suppressing blurring, improving storage stability and ejection stability from an ink jet recording head, an ink containing a quinacridone pigment and/or a phthalocyanine pigment, a polymer dye formed by a salt formation of a dye to a polymer compound, a specified surfactant, and a urea derivative is proposed (Patent Documents 8 and 9).

Patent Document 1: JP-A-64-6074

Patent Document 2: JP-A-64-31881

Patent Document 3: JP-A-3-252467

Patent Document 4: JP-A-3-79680

Patent Document 5: JP-A-8-183920

Patent Document 6: JP-A-9-40895

Patent Document 7: JP-A-2004-59799

Patent Document 8: JP-A-10-36741

Patent Document 9: JP-A-10-53740

In order to use a pigment in an ink composition for ink jet recording, it is important to stably disperse the pigment in water and to retain such state for a prolonged period as described above, but the above-described background technologies (Patent Documents 1-9) are not fully satisfactory.

Also the ink for ink jet recording method contains, in addition to the colorant, various additives for optimizing various characteristics in the ink jet recording method, particularly a water-soluble organic solvent. Such water-soluble organic solvent includes, for example, a humectant for preventing a drying, a penetrating solvent or a surfactant for reducing a surface tension of the ink composition thereby controlling a penetrating property into the recording medium, and an organic amine for regulating a pH value of the ink composition. Some of such solvents influence the dispersed colorant and hinder the dispersibility thereof, thereby deteriorating the storage stability of the ink composition. Particularly, there has been a problem that such influences often appear in a solvent having a high affinity to a pigment surface having a hydrophobic surface or a hydrophobic portion of the dispersant. Also in case of such influences, the dispersing polymer serving as a dispersant is liberated from the pigment surface and is dissolved in the ink, which results in, when used in an ink jet recording, an unstable ejection from the recording head.

Also in the above-described background technology (Patent Documents 5 and 6), the aqueous ink using a dispersing polymer of which 60 mol. % or more of the acid groups are neutralized with an alkaline neutralizer may cause a mutual interaction of the dispersing polymer and the water-soluble organic solvent depending upon the type of the water-soluble organic solvent, thus resulting in a drawback of deterioration in the storage stability and ejection stability of the ink.

Also in the background technologies (Patent Documents 1-9), the dispersant used for dispersing the pigment is partly dissolved out into the ink and functions as an ink penetrating agent, thereby enhancing ink penetration property into the recording medium beyond necessity. Therefore the pigment particles may penetrate into the recording medium as if entrained by such penetration property thereby resulting in poor color development of the image. Such phenomenon is particularly conspicuous in a plain paper or a recycled paper, causing in some cases blurring due to excessive penetration or a strike through in which the ink penetrates to the back side of paper, which thus induces an image quality deterioration.

### SUMMARY OF THE INVENTION

In consideration of the foregoing, an object of the present invention is to provide an aqueous ink composition suitable for use as an ink jet recording ink, and capable of showing high storage stability and high ejection stability, with reduced blurring, density unevenness and strike through and a high image density on a plain paper or a recycled paper, and with reduced blurring and density unevenness and an excellent gloss on a glossy paper or the like.

Other objects and effects of the invention will become apparent from the following description.

An aqueous ink composition of the present invention is an aqueous ink composition comprising a coloring component, an acetylene glycol-based surfactant, water, and a urea derivative,

wherein the coloring component is a dispersion substance in which a colorant is enclosed with a dispersing polymer thereby being rendered dispersible in water,

wherein the dispersing polymer comprises a hydrophobic part and a hydrophilic part,

wherein at least a part of the hydrophilic part is a neutralized group obtained by neutralizing an unneutralized group constituting a part of the hydrophilic part, and

wherein the neutralized groups are present within an amount range of from 20% to less than 60% in terms of molar ratio based on the sum of the neutralized groups and the unneutralized groups.

The aqueous ink composition of the invention preferably further comprises a humectant.

The aqueous ink composition of the invention preferably further comprises a penetrating solvent.

In the aqueous ink composition of the invention, the penetrating solvent is preferably selected from the group consisting of a monohydric alcohol, a glycol monoether derivative of a polyhydric alcohol, and a 1,2-alkyldiol.

The aqueous ink composition of the invention preferably further comprises a resin emulsion.

The resin emulsion preferably comprises at least a resin emulsion comprising a resin having a glass transition temperature (Tg) of 30° C. or higher.

In a preferred embodiment of the aqueous ink composition of the invention, the colorant is carbon black.

In a preferred embodiment of the aqueous ink composition of the invention, the colorant is an organic pigment.

The aqueous ink composition of the invention preferably further comprises a weakly alkalizing agent and is rendered alkaline.

The weakly alkalizing agent preferably comprises at least a compound selected from an organic acid salt and an organic buffer.

Also the present invention provides an ink jet recording method in which comprises ejecting a liquid droplet of an aqueous ink composition described in any of the foregoing items, and depositing the liquid droplet onto a recording medium to perform recording.

Also the present invention provides recorded matter obtained by an ink jet recording method, using an aqueous ink composition described in any one of the foregoing items.

### DETAILED DESCRIPTION OF THE INVENTION

The aqueous ink composition of the present invention is an aqueous ink composition comprising a coloring component, an acetylene glycol-based surfactant, water, and a urea derivative, wherein the coloring component is a dispersion substance in which a colorant is enclosed with a dispersing polymer thereby being rendered dispersible in water; the dispersing polymer comprises a hydrophobic part and a hydrophilic part; at least a part of the hydrophilic part is a neutralized group obtained by neutralizing an unneutralized group constituting a part of the hydrophilic part; and the neutralized groups are present within an amount range of from 20% to less than 60% in terms of molar ratio based on the sum of the neutralized groups and the unneutralized groups.

In another embodiment, the aqueous ink composition of the invention further comprises a humectant, in addition to the aforementioned components.

In still another embodiment, the aqueous ink composition of the invention further comprises a penetrating solvent, in addition to the aforementioned components.

In still another embodiment, the aqueous ink composition of the invention further comprises a resin emulsion, in addition to the aforementioned components.

In still another embodiment, the aqueous ink composition of the invention further comprises a weakly alkalizing agent, in addition to the aforementioned components.

Such constitutions provide an aqueous ink composition adapted for use in an ink jet recording, and capable of showing high storage stability and high ejection stability in ink jet recording,

without blurring, density unevenness and strike through and with a high image density on a plain paper or a recycled paper, and

without blurring and density unevenness and with an excellent gloss on a glossy medium such as a glossy paper.

In the foregoing, it is essential that the dispersing polymer has a hydrophobic part and a hydrophilic part in combination. A dispersing polymer without a hydrophobic part entirely dissolves in water and does not function as a dispersing polymer, whereby a stable colorant dispersion cannot be obtained. Also such liberated polymer, dissolved in water, induces an unstable ejection of the aqueous ink composition from the recording head. Also it excessively penetrates in the recording medium, particularly a plain paper or a recycled paper, thus resulting in an image involving blurring, density unevenness and strike through with a low recording density. On the other hand, a dispersing polymer without a hydrophilic part is incapable of a stable dispersion of the colorant by the polymer, whereby the colorant dispersion causes an agglomeration or a sedimentation. In order to avoid such drawback, it is essential, as will be explained later in more details, that a neutralized group, constituting a part of the hydrophilic part of the dispersing polymer, is a group obtained by neutralizing an unneutralized group, constituting a part of the hydrophobic part, and that the neutralized groups are present in an amount of from 20% to less than 60% in terms of molar ratio based on the sum of the unneutralized groups and the neutralized groups.

In the following, constituents of the aqueous ink composition of the invention will be explained.

<Aqueous Ink Composition>

Dispersing Polymer

In the aqueous ink composition of the invention, the dispersing polymer can be, without particular restriction, any polymer that is singly insoluble in water and is soluble in an organic solvent to be employed in the preparation of a dispersion substance as later explained in examples (particularly a hydrophilic organic solvent such as acetone or methyl ethyl ketone), but is required to have a polymer structure including a hydrophobic part and a hydrophilic part.

The hydrophobic part means a repeating unit including an alkyl group, a cycloalkyl group, an aromatic ring or an unneutralized group. An unneutralized group means a group that can be neutralized with a neutralizer, and can be an acid group or an alkaline group. More specifically, the unneutralized group can be a carboxylic acid group or a sulfonic acid group.

Also the hydrophilic part means a repeating unit including a hydroxyl group, an amino group, an amide group and a neutralized group. A neutralized group means a group formed by neutralizing an unneutralized group, and is preferably an ionic group. The unneutralized group and the neutralized group are preferably anionic groups, and, in a particularly preferred case, the unneutralized group is a carboxylic acid group and the neutralized group is a carboxylate anionic group (group of a carboxylic acid salt). The carboxylic acid salt can be, for example, lithium carboxylate, sodium carboxylate, potassium carboxylate or ammonium carboxylate.

The dispersing polymer having the above-described structure can be firmly adsorbed, by the hydrophobic part, to a hydrophobic surface of the colorant to be explained later, thereby enclosing the colorant. Also as it can show an affinity to water by the hydrophilic part, it can constitute a dispersion substance, stably dispersible in water.

A dispersing polymer having an anionic group can be obtained by polymerizing a monomer having an anionic group (hereinafter called an anionic group-containing monomer), and, if necessary, another monomer capable of copolymerizing with such monomer, in a solvent. The anionic group-containing monomer can be, for example, a monomer having a carboxylic acid group or a monomer having a sulfonic acid group.

The monomer having a carboxylic acid group is preferably an acrylic monomer having one or two carboxylic acid groups within a repeating unit.

Specific examples of the monomer having a carboxylic acid group include acrylic acid, methacrylic acid, crotonic acid, ethacrylic acid, propylacrylic acid, isopropylacrylic acid, itaconic acid, fumaric acid, and maleic acid, among which acrylic acid, methacrylic acid or maleic acid is preferred.

Specific examples of the monomer having a sulfonic acid group include styrenesulfonic acid, isoprenesulfonic acid, sulfobutyl methacrylate, and allylsulfonic acid. It is also preferable, after a resin polymerization, to execute a sulfonation with a sulfonating agent such as nitric acid, fuming sulfuric acid or sulfamic acid.

Specific examples of another monomer capable of copolymerizing with the anionic group-containing monomer include a (meth)acrylic acid ester such as methyl acrylate, ethyl acrylate, isopropyl acrylate, n-propyl acrylate, n-butyl acrylate, t-butyl acrylate, 2-ethylhexyl acrylate, n-octyl acrylate, lauryl acrylate, benzyl acrylate, methyl methacrylate, ethyl methacrylate, isopropyl methacrylate, n-propyl methacrylate, n-butyl methacrylate, isobutyl methacrylate, t-butyl methacrylate, 2-ethylhexyl methacrylate, n-octyl methacrylate, lauryl methacrylate, stearyl methacrylate, tridecyl methacrylate, or benzyl methacrylate; an adduct of a fatty acid and a(meth)acrylic acid ester monomer having an oxirane structure such as an adduct of stearic acid and glycidyl methacrylate; an adduct of an oxirane compound containing an alkyl group with 3 or more carbon atoms and (meth)acrylic acid; a styrenic monomer such as styrene, α-methylstyrene, o-methylstyrene, m-methylstyrene, p-methylstyrene, or p-tert-butylstyrene; an itaconic acid ester such as benzyl itaconate; a maleic acid ester such as dimethyl maleate; a fumaric acid ester such as dimethyl fumarate; acrylonitrile, methacrylonitrile, vinyl acetate, isobornyl acrylate, isobornyl methacrylate, aminoethyl acrylate, aminopropoyl acrylate, methylaminoethyl acrylate, methylaminopropyl acrylate, ethylaminoethyl acrylate, ethylaminopropyl acrylate, aminoethylamide acrylate, aminopropylamide acrylate, methylaminoethylamide acrylate, methylaminopropylamide acrylate, ethylaminoethylamide acrylate, ethylaminopropylamide acrylate, amide methacrylate, aminoethyl methacrylate, aminopropyl methacrylate, methylaminoethyl methacrylate, methylaminopropyl methacrylate, ethylaminoethyl methacrylate, ethylaminopropyl methacrylate, aminoethylamide methacrylate, aminopropylamide methacrylate, methylaminoethylamide methacrylate, methylaminopropylamide methacrylate, ethylaminoethylamide methacrylate, ethylaminopropylamide methacrylate, hydroxymethyl methacrylate, 2-hydroxyethyl acrylate, 2-hydroxypropyl acrylate, hydroxymethyl methacrylate, 2-hydroxyethyl methacrylate, 2-hydroxypropyl methacrylate, N-methylolacrylamide, and allyl alcohol.

Such dispersing polymer preferably has a weight-average molecular weight within a range of about 1,000-200,000, particularly preferably about 3,000-150,000. The dispersing polymer having a weight-average molecular weight in such range can fully exhibit a function as a covering film on the colorant or a coating film in the aqueous ink composition.

An alkaline compound for neutralizing a part of the unneutralized groups in the dispersing polymer having the anionic group can be an organic amine or an alkali metal salt compound. Specific examples of the organic amine include a salt of a volatile amine compound such as ammonia, triethylamine, tributylamine, dimethylethanolamine, diisopropanolamine, or morpholine, and a salt of a less-volatile high-boiling organic amine such as diethanolamine, triethanolamine or tripropanolamine. Specific examples of the alkali metal salt compound include a compound having lithium, sodium or potassium as an alkali metal, preferably an alkali metal hydroxide such as sodium hydroxide, potassium hydroxide or lithium hydroxide, and more preferably potassium hydroxide.

In the coloring component in the aqueous ink composition of the invention, a balance of the hydrophobic part and the hydrophilic part of the dispersing polymer described above is important, and an amount of the neutralized groups constituting a part of the hydrophilic part significantly affects a dispersion stability of the dispersion substance, ejection stability from the recording head, and a recording quality of the recorded matter. A ratio of the neutralized groups has to be in a range of from 20% to less than 60% in terms of molar ratio based on the sum of the unneutralized groups constituting a part of the hydrophobic part in the dispersing polymer and the neutralized groups constituting a part of the hydrophilic part. Such range allows to obtain an aqueous ink composition excellent in the storage stability, the ejection stability and the recording quality. An amount of the neutralized groups less than 20% excessively increases the hydrophobic part, leading to an unstable dispersion of the colorant and the like by the dispersing polymer whereby the colorant dispersion tends to cause agglomeration and sedimentation. On the other hand, an amount of the neutralized groups equal to or higher than 60% excessively decreases the hydrophobic part, whereby the entire dispersing polymer becomes singly soluble in water. In such situation, a liberated polymer, not adsorbed on the colorant, increases to induce an unstable ejection from the recording head. Also the water-solubilized dispersing polymer functions as a penetrating agent to induce an unnecessarily large penetration of the ink into the recording medium, thereby tending to generate drawbacks such as blurring or a strike through on the image.

In the dispersing polymer, an amount of the anionic group is such that an acid value is about 30 KOHmg/g or higher, preferably within a range of about 50-250 KOHmg/g. An acid value of the dispersing polymer within such range improves the storage stability of the coated colorant particles and also improves the water resistance of the recorded image.

The coloring component, which is a dispersion substance of the colorant dispersed with the above-described dispersing polymer, allows to realize an aqueous ink composition, adapted for use in an ink jet recording, showing excellent storage stability and excellent ejection stability, and capable of providing an image with reduced blurring, density unevenness and strike through and with a high recoding density particularly in case of recording on a plain paper or a recycled paper. Reasons therefor has not been clarified but are estimated as follows.

In a plain paper or a recycled paper, a chemical called “sizing agent” is added for suppressing blurring of an ink for example of a fountain pen. Such “sizing agent is hydrophobic in comparison with cellulose fibers which are a principal constituent of the plain paper or the recycled paper. The conventional aqueous pigment-based ink employs a water-soluble resin or a water-soluble surfactant rich in hydrophilicity as a dispersant for the pigment particles. As a result, the conventional aqueous pigment-based ink is repelled by a portion rich in such “sizing agent” and the pigment particles flow therewith, thus inducing blurring, density unevenness and a strike through on the plain paper or the recycled paper thereby deteriorating the recording quality. In contrast, the dispersing polymer of the dispersion substance, employed in the aqueous ink composition of the invention, is more hydrophobic in comparison with the water-soluble resin or the water-soluble surfactant used as the dispersant in the conventional pigment dispersion substance, and is not repelled by and is uniformly deposited also in the portion rich in the “sizing agent”, thereby providing an image with reduced blurring and density unevenness. Also the dispersing polymer, because of its hydrophobicity also to the cellulose fibers, is deposited relatively in the surfacial part. As a result, the pigment present in the dispersing polymer is present more on the surface of the plain paper or the recycled paper, thereby reducing the strike through and improving the density of the recorded image.

Colorant

The colorant, as a colorant insoluble or little soluble in an aqueous medium, can for example be an organic pigment, carbon black, an oil-soluble dye, or a dispersion dye. Carbon black and an organic pigment are particularly preferred because of a satisfactory color developing property and of a low specific gravity which hinders sedimentation at the dispersing operation.

In the aqueous ink composition of the invention, such colorant is dispersed by the dispersing polymer (preferably polymer having an anionic group).

Specific examples of carbon black preferred in the present invention include those manufactured by Mitsubishi Chemical Corp., such as No. 2300, 900, MCF88, No. 20B, No. 33, No. 40, No. 45, No. 52, MA7, MA8, MA100, and No. 2200B; those manufactured by Degussa Corp. such as Color Black FW1, FW2, FW2V, FW18, FW200, S150, S160, S170, Pretex 35, U, V, 140U, Special Black 6, 5, 4A, 4 and 250; those manufactured by Columbia Carbon Inc. such as Conductex SC, Raven 1255, 5750, 5250, 5000, 3500, 1255, and 700; and those manufactured by Cabot Corp. such as Regal 400R, 330R, 660R, Mogul L, Monarch 700., 800, 880, 900, 1000, 1100, 1300, 1400 and Elftex 12. These are mere examples of carbon black suitable for the present invention, and the present invention is not limited to such examples. Such carbon black may be employed singly or as a mixture of two or more kinds. Such pigment is added in an amount of 0.5-15 wt. % with respect to the entire aqueous ink composition, preferably 1-10 wt. %.

The organic pigment preferred in the present invention can be, for example, a quinacridone pigment, a quinacridonequinone pigment, a dioxadine pigment, a phthalocyanine pigment, an anthrapyrimidine pigment, an anthanthrone pigment, an indanthrone pigment, a flavanthrone pigment, a perylene pigment, a diketopyrrolopyrrole pigment, a perynone pigment, a quinophthalone pigment, an anthraquinone pigment, a thioindigo pigment, a benzimidazolone pigment, an isoindolinone pigment, an azomethine pigment or an azo pigment.

Specific examples of the organic pigment for use in the aqueous ink composition of the invention are as follows.

A pigment to be employed in a cyan ink composition can be, for example, C.I. Pigment Blue 1, 2, 3, 15:3, 15:4, 15:34, 16, 22 or 60; C.I. Vat Blue 4, or 60, preferably one, or a mixture or two or more, selected from a group of C.I. Pigment Blue 15:3, 15:4 and 60. Such pigment is added in an amount of about 0.5-15 wt. % with respect to the cyan ink composition, preferably about 1-10 wt. %.

A pigment to be employed in a magenta ink composition can be, for example, C.I. Pigment Red 5, 7, 12, 48(Ca), 48(Mn), 57(Ca), 57:1, 112, 122, 123, 168, 184, 202; or C.I. Pigment Violet 19, preferably one, or a mixture or two or more, selected from a group of C.I. Pigment Red 122, 202, 209 and C.I. Pigment Violet 19. Such pigment is added in an amount of about 0.5-15 wt. % with respect to the magenta ink composition, preferably about 1-10 wt. %.

A pigment to be employed in a yellow ink composition can be, for example, C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180 or 185, preferably one, or a mixture or two or more, selected from a group of C.I. Pigment Yellow 74, 109, 110, 128 and 138. Such pigment is added in an amount of about 0.5-15 wt. % with respect to the yellow ink composition, preferably about 1-10 wt. %.

A pigment to be employed in an orange ink composition can be, for example, C.I. Pigment Orange 36 or 43 or a mixture thereof. Such pigment is added in an amount of about 0.5-15 wt. % with respect to the orange ink composition, preferably about 1-10 wt. %.

A pigment to be employed in a green ink composition can be, for example, C.I. Pigment Green 7 or 36 or a mixture thereof. Such pigment is added in an amount of about 0.5-15 wt. % with respect to the green ink composition, preferably about 1-10 wt. %.

In the aqueous ink composition of the invention, a ratio of the colorant and the dispersing polymer is, in a weight ratio, preferably 10:1-1:10, more preferably 4:1-1:3. Also at the dispersing operation, the colorant has, when measured by a dynamic light scattering method, a maximum particle size less than 500 nm and an average particle size of 300 nm or less, more preferably an average particle size of 200 nm or less.

Acetylene Glycol-Based Surfactant

The aqueous ink composition of the invention includes an acetylene glycol-based surfactant, which is an additive for controlling the ink penetration property to the recording medium. The acetylene glycol-based surfactant has no or little foaming property and is particularly useful in case of applying the aqueous ink composition of the invention to an ink jet recording. Specific examples of the acetylene glycol-based surfactant preferred in the invention include Surfynol 104, Surfynol 104E, Surfynol 104H, Surfynol 104A, Surfynol 104BC, Surfynol 104DPM, Surfynol 104PA, Surfynol 104PG-50, Surfynol 104S, Surfynol 420, Surfynol 440, Surfynol 465, Surfynol 485, Surfynol SE, Surfynol SE-F, Surfynol 504, Surfynol DF37, Surfynol CT111, Surfynol CT121, Surfynol CT131, Surfynol CT136, Surfynol TG, and Surfynol GA (foregoing trade names of Air Products and Chemicals, Inc.), Olfin SPC, Olfin E1004, Olfin E1010, and Olfin AK-02 (foregoing trade names of Nisshin Chemical Co.), Acetylenol EOO, Acetylenol EOOP, Acetylenol E40 and Acetylenol E100 (foregoing trade names of Kawaken Fine Chemical Co.).

An amount of addition of such acetylene glycol-based surfactant may be suitably determined according to a desired ink penetration time, but is preferably 0.01-10 wt. % with respect to the entire aqueous ink composition.

The acetylene glycol-based surfactant explained above has scarce dissolving power on the dispersing polymer, and exerts a function of stably maintaining a dispersed state of the dispersion in which the dispersing polymer is dispersed. Therefore, the aqueous ink composition of the invention, even containing the acetylene glycol-based surfactant, is almost free from a liberated dispersing polymer not adsorbed to the surface of the colorant such as the pigment or a dissolved resin component, and can therefore secure high storage stability and high ejection stability.

Also such acetylene glycol-based surfactant has an excellent property as a penetrating component, and an aqueous ink composition containing the same is improved in the wetting property and the penetrating speed regardless of the type of the recording medium, thereby becoming excellent in the penetrating property and the drying property. Particularly in combination with the above-described dispersion substance employed in the aqueous ink composition of the invention, it shows an excellent effect of improving the penetrating speed without deteriorating the characteristics, inherent to the dispersion substance itself, of showing little blurring, density unevenness and strike through and a high image density on a plain paper or a recycled paper, whereby a sharp image can be obtained even under an increased recording speed.

Urea Derivative

The aqueous ink composition of the invention includes a urea derivative. Such urea derivative, when contained in the aqueous ink composition of the invention, shows an effect of providing an image with an excellent gloss when an image is recorded on a glossy medium such as a glossy paper or a photo paper. In addition, the urea derivative has a moisture retaining property, thus being excellent in suppressing an ink drying at a distal end of an ink nozzle aperture in the recording head.

The aqueous ink composition of the invention includes a dispersion substance in which a colorant (particularly a pigment) is enclosed with a dispersing polymer thereby being rendered dispersible in water, wherein the dispersing polymer comprises a hydrophobic part and a hydrophilic part; at least a part of the hydrophilic part is a neutralized group obtained by neutralizing an unneutralized group constituting a part of the hydrophilic part; and the neutralized groups are present within an amount range of from 20% to less than 60% in terms of molar ratio based on the sum of the neutralized groups and the unneutralized groups. Such dispersion substance, being more hydrophobic than the dispersion substance employed in the conventional aqueous pigment-based ink as explained above, can provide a sharp image with reduced blurring, density unevenness and strike through and a high image density particularly in case of recording on a plain paper or a recycled paper. However, on a glossy medium such as a glossy paper or a photo paper, such hydrophobicity poses a problem that, on certain glossy media, the particles of the dispersion substance become present in an uneven state on the surface thereof, thus becoming unable to obtain a satisfactory gloss in the recorded matter. However, as a result of studies undertaken by the present inventors, it is confirmed that an addition of a urea derivative can improve the gloss. Reasons therefor are not yet clarified, but are estimated as follows.

An ink absorbing layer of a glossy medium is representatively formed by coating and drying a coating liquid formed by a mixture of amorphous silica or the like and a binder such as polyvinyl alcohol, and a cationic substance is often added in order to develop a water resistance in case of employing a dye-based ink. Also the dispersion substance employed in the aqueous ink composition of the invention includes, on a surface thereof, a hydrophilic part constituted of a neutralized group such as a carboxylate anionic group or a sulfonate anionic group, for achieving a stable dispersion in water. Consequently, on a glossy paper, such neutralized group combines with the cationic substance to form an unneutralized group such as a carboxylic acid group or a sulfonic acid group, whereby the dispersion substance shows a decrease in the hydrophilic part on the surface thereof and becomes incapable of retaining the dispersing property, thereby being present on the surface of the glossy medium as coarse agglomerates. In such situation, the image loses a surface smoothness and becomes an image poor in gloss. A urea derivative, showing a weak cationic property by a nitrogen atom contained in the molecule thereof, is assumed to show a buffering effect for suppressing a coupling of the cationic substance on the glossy medium with the neutralized group. In such process, the formation of the coarse agglomerates of the dispersion substance can be prevented until a liquid component such as water of the ink is absorbed into the interior of the glossy medium, whereby particles of the dispersion substance can be fixed uniformly to the surface of the glossy medium with a particle size substantially same as that in the ink state, thereby providing a satisfactory smoothness on the image. Therefore the obtained image is estimated to be improved in gloss for such reasons.

Specific examples of the urea derivative having such function include allylurea, dimethylolurea, malonylurea, carbamylurea, n-butylurea, dibutylurea, N,N-dimethylurea, 1,3-dimethylurea, N-methylurea, hydroxyurea, ethylurea, methylurea, creatinine, 1-acetyl-2-thiourea, N-acetylthiourea, N-(1-adamantyl)urea, aminodithiourea, aminourea hydrochlorate, allylthiourea, 1-allyl-2-thiourea, imidurea, 2-imidazolidinurea, 1-(2-chlorophenyl)-2-thiourea, guanylurea sulfate, sodium cyanourea, sodium 1-cyano-3-methylisothiourea, 1-cyclohexyl-3-(2-morpholinoethyl)thiourea, 1,3-diallylurea, 1,3-diethyl-2-thiourea, 1-(3,4-dichlorophenyl)-2-thiourea, N,N′-dicyclohexylurea, 1,3-diphenylthiourea, 1,3-diphenylurea, 1,3-dibutyl-2-thiourea, 1,1-dimethyl-2-selenourea, 1,3-dimethylthiourea, N,N′-dimethylthiourea, selenourea, tetramethylthiourea, 1,1,3,3-tetramethylurea, tetramethylurea, σ-tolylurea, m-tolylurea, 1-(1-naphthyl)-2-thiourea, 1-(3-hydroxyphenyl)urea, 1,3-bis(trimethylsilyl)urea, N,N-bis(2-hydroxyethyl)-N′-(α,α-dimethyl-3-isopropenylbenzyl)urea, N,N-bis(2-hydroxypropyl)-N′-(α,α-dimethyl-3-isopropenylbenzyl)urea, N,N′-bis(hydroxymethyl)urea, phenylacetylurea, phenylethylthiourea, 1-phenyl-3-(2-thiazolyl)-2-thiourea, 1-phenyl-2-thiourea, phenylurea, tert-butylurea, 2-benzyl-2-thiopseudourea hydrochlorate, benzylurea, N-formylurea, malonylthiourea, 1-methallyl-3-methyl-2-thiourea, o-methylisourea hemisulfate, N-methylthiourea, and 2-methyl-2-thiopseudourea sulfate. Among these, malonylurea, carbamylurea, N,N-dimethylurea, 1,3-dimethylurea, N-methylurea, creatinine, 1-allyl-2-thiourea, 2-imidazolidinethione, and 1,1,3,3-tetramethylurea are preferred because of a relatively high solubility in water, thus being easily soluble in the aqueous ink composition. Such urea derivative, having a considerable effect of retaining moisture, can have an effect as a humectant to be explained in the following. It can therefore suppress an ink drying at the distal end of the ink nozzle aperture in the recording head, thereby suppressing drawbacks such as nozzle clogging or a skewed flight of the ink droplet.

Such urea derivative may be employed singly or in a combination of two or more kinds. An amount of the urea derivative is not particularly restricted within a range completely soluble in the aqueous ink composition and capable of improving the image gloss, but is preferably within a range of 0.1-20 wt. % with respect to the entire aqueous ink composition. An amount less than 0.1 wt. % may be unable to show an improvement in the image gloss, and an amount exceeding 20 wt. % may result in drawbacks such as an incomplete dissolving.

The urea derivative explained above provides, when employed in combination with the dispersion substance and the acetylene glycol-based surfactant explained before, an image without blurring, density unevenness and strike through and with a high recording density on a plain paper or a recycled paper, and an image without blurring and density unevenness and with an excellent gloss on a glossy medium such as a glossy paper or a photo paper.

Water

Water is a principal component of the aqueous ink composition of the invention, and, for the purpose of minimizing ionic impurities, water purified by an ion exchange, an ultrafiltration, a reverse osmosis, or a distillation or deionized water can be employed preferably.

Also water sterilized by an ultraviolet irradiation or an addition of hydrogen peroxide is advantageous in avoiding growth of molds and bacteria in a prolonged storage of the aqueous ink composition.

The aqueous ink composition of the invention contains the dispersion substance formed by the dispersing polymer including the colorant, the acetylene glycol-based surfactanct, the urea derivative and the water as essential components, and, when constituted of such components, is satisfactory in the storage stability and the ejection stability of the ink, thus providing an image with reduced blurring, density unevenness and strike through with a high image density on a plain paper or a recycled paper and an image with a satisfactory gloss on a glossy medium, but may further contain, if necessary, following components for further improving various characteristics. Such components will be explained in the following.

Humectant

In another embodiment, the aqueous ink composition of the invention may contain a humectant. The humectant is added to suppress a drying of the aqueous ink composition, and has a function of suppressing the evaporation of water by drying at the nozzle distal end in the recording head, thereby preventing agglomeration or solidification of the aqueous ink composition.

The humectant is selected from water-soluble material of a high hygroscopic property, and can be a polyol such as glycerin, ethylene glycol, diethylene glycol, triethylene glycol, tetraethylene glycol, polyethylene glycol, propylene glycol, dipropylene glycol, polypropylene glycol, 1,3-propanediol, 1,4-butanediol, 1,5-pentanediol, 2,3-butanediol, 2-methyl-2,4-pentanediol, 2-ethyl-1,3-hexanediol, 1,2,6-hexanetriol or pentaerythritol, or a lactam such as 2-pyrrolidone or N-methyl-2-pyrrolidone.

Also for the purpose of complementing the ability of the above-mentioned material, a water-soluble solid humectant may be added in combination. Specific examples include a diol such as 1,6-hexanediol, 1,8-octanediol, 2,2-dimethyl-1,3-propanediol, or 2,2-diethyl-1,3-propanediol; trimethylolethane; trimethylolpropane; a lactam such as ε-caprolactam; a monosaccharide, a disaccharide, an oligosaccharide and a polysaccharide such as glucose, mannose, fructose, ribose, xylose, arabinose, galactose, aldonic acid, glusitol (sorbit), maltose, cellobiose, lactose, sucrose, trehalose, or malttriose; and a derivative of such saccharides such as a reduced saccharide, an oxidized saccharide, an amino acid or a thiosaccharide. A sugar alcohol is particularly preferable, such as maltitol or sorbit.

Such humectant is preferably added, either singly or in a mixture of plural kinds, in an amount of 40 wt. % or less with respect to the entire aqueous ink composition, more preferably 30 wt. % or less. Such humectant may be added, in a combination with other additives, in such an amount providing an ink viscosity of 25 cPs or less at 25° C.

Penetrating Solvent

In another embodiment, the aqueous ink composition of the invention may further contain a penetrating solvent. The penetrating solvent herein is an additive for increasing the penetration property of the ink into the recording medium, and is suitably selected according to a desired ink drying time.

The penetrating solvent is preferably selected from a material having a function of reducing the surface tension of the aqueous ink composition, for example from a glycol monoether derivative of a polyhydric alcohol and a 1,2-alkyldiol.

The 1,2-alkyldiol is preferably a 1,2-alkyldiol with 4-8 carbon atoms, such as butanediol, pentanediol, hexanediol, heptanediol or octanediol. Among these, 1,2-hexanediol, 1,2-heptanediol and 1,2-octanediol having 6-8 carbon atoms have a strong penetrating ability into the recording medium and are particularly preferable. Such 1,2-alkyldiol is preferably added in an amount of 5 wt. % or less with respect to the entire aqueous ink composition.

The glycol monoether derivative of polyhydric alcohol is preferably a derivative of a tri- or higher-hydric alcohol. Specific examples include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene. glycol mono-n-butyl ether, dipropylene glycol mono-n-butyl ether, dipropylene glycol mono-n-propyl ether, and dipropylene glycol mono-iso-propyl ether. The glycol monoether derivative of polyhydric alcohol is preferably added in a range of 15 wt. % or less with respect to the entire aqueous ink composition.

Other examples of the penetrating solvent include a water-soluble monohydric alcohol such as methanol, ethanol, n-propyl alcohol, iso-propyl alcohol, 2,2-dimethyl-1-propanol, n-butanol, 2-butanol, tert-butanol, iso-butanol, 2-methyl-1-butanol, 3-methyl-l-butanol, 3-methyl-2-butanol, n-pentanol, 2-pentanol, 3-pentanol, or tert-pentanol. Such monohydric alcohol is preferably added within a range of 10 wt. % or less with respect to the entire aqueous ink composition.

Such penetrating solvent as listed above may be employed singly or in a mixture of two or more kinds. Particularly a combination of plural penetrating solvents of different structures allows to obtain a same image quality on various recording media different in the penetration property and in the color developing property, and is preferable in the adaptability to the types of the recording media.

Also in case of an aqueous ink composition with a relatively long drying time, a humectant capable of showing a relatively low surface tension in the aqueous solution may be employed as a substitute for the penetrating solvent, and, in such case, the aqueous ink composition may be formed without adding the penetrating solvent mentioned above.

The penetrating solvent described above has a scarce dissolving power on the dispersing polymer, and has a function of stably maintaining the dispersion in which the dispersing polymer is dispersed. Therefore, the aqueous ink composition of the invention, even containing the penetrating solvent as described above, is almost free from a liberated dispersing polymer not adsorbed to the surface of the colorant such as the pigment, and can therefore secure high storage stability and high ejection stability.

Also such penetrating solvent, particularly employed in combination with the acetylene glycol-based surfactant required essentially in the aqueous ink composition of the invention, shows an excellent property as a penetrating component, thus further improving the wetting property and the penetrating speed and providing characteristics excellent in the penetration property and the drying property. Therefore, such penetrating solvent employed in the aqueous ink composition of the invention provides an advantage of obtaining an image of an excellent recording quality with further reduced blurring, density unevenness and strike through and a high image density regardless of the type of the recording medium.

Resin Emulsion

In another embodiment, the aqueous ink composition of the invention may further contain a resin emulsion. The resin emulsion has functions of suppressing the penetration of the dispersion substance into the recording medium thereby improving the color developing property thereof, and also improving the fixing property since the resin emulsion is fused by itself or together with the dispersion substance in the course of drying to fix the pigment particles onto the recording medium. A resin component constituting a resin emulsion having such properties can be an acrylic resin, a methacrylic resin, a styrene resin, an urethane resin, an acrylamide resin, or an epoxy resin, or a mixture of such resins. Among these resin components, more preferred is a styrene-acrylic acid copolymer, a styrene-acrylic acid-alkyl acrylate copolymer, a styrene-maleic acid copolymer, a styrene-maleic acid-alkyl acrylate copolymer, a styrene-methacrylic acid copolymer, a styrene-methacrylic acid-alkyl acrylate copolymer, or a styrene-maleic acid half ester copolymer.

It is essential that such resin component has both a hydrophobic part and a hydrophilic part in its structure. The hydrophobic part means a repeating unit including an alkyl group, a cycloalkyl group, an aromatic ring or an unneutralized group. An unneutralized group means a group that can be neutralized with a neutralizer, and can be an acid group or an alkaline group. More specifically, the unneutralized group can be a carboxylic acid group or a sulfonic acid group.

Also the hydrophilic part means a repeating unit including a hydroxyl group, an amino group, an amide group and a neutralized group. A neutralized group means a group formed by neutralizing an unneutralized group, and is preferably an ionic group. The unneutralized group and the neutralized group are preferably anionic groups, and, in a particularly preferred case, the unneutralized group is a carboxylic acid group and the neutralized group is a carboxylate anionic group (group of a carboxylic acid salt). The carboxylic acid salt can be, for example, lithium carboxylate, sodium carboxylate, potassium carboxylate or ammonium carboxylate.

Owing to the above-described structure of the resin component constituting the resin emulsion, the hydrophobic part remains inside the resin emulsion and is separated from water while the hydrophilic part is present on the surface of the resin emulsion to exhibit affinity to water, thereby constructing a resin emulsion stably dispersed in water. Also when deposited on the recording medium, the resin emulsion is fused by itself or together with the dispersion substance to form a film in which the hydrophobic part covers the surface thereof. Such film is insoluble in water and is not re-dispersed, and firmly sticks to the recording medium together with the dispersion substance, thereby providing an image satisfactory in the fixing property and the water resistance.

Such resin emulsion may be so synthesized as to meet various requirements, but a commercially available product may be employed for this purpose. Specific examples of the commercially available product include Mowinyl 701 (Tg: −10° C.), Mowinyl 743 (Tg: 39° C.), Mowinyl 745 (Tg: 21° C.), Mowinyl 940 (Tg: 1° C.), Mowinyl 1930 (Tg: 1° C.), Mowinyl 664 (Tg: 6° C.), Mowinyl DM5 (Tg: −3° C.), Mowinyl 700 (Tg: −2° C.), Mowinyl 792 (Tg: −2° C.), Mowinyl DM772 (Tg: 3° C.), Mowinyl 865 (Tg: 1° C.), Mowinyl 870 (Tg: 19° C.), Mowinyl 928 (Tg: 5° C.), Mowinyl 1750T (Tg: 16° C.), Mowinyl 1751 (Tg: 16° C.), Mowinyl 1760 (Tg: 7° C.), Mowinyl LDM6316 (Tg: 17° C.), Mowinyl 7200 (Tg: 24° C.), Mowinyl 727 (Tg: 5° C.), Mowinyl 752 (Tg: 16° C.), Mowinyl 837 (Tg: 10° C.), Mowinyl 860 (Tg: 3° C.), Mowinyl 864 (Tg: 4° C.), Mowinyl 864M (Tg: 4° C.), Mowinyl DM60 (Tg: 0° C.), Mowinyl DM765 (Tg: −19° C.), Mowinyl 937 (Tg: −42° C.), Mowinyl 1906 (Tg: −45° C.), Mowinyl LDM6300 (Tg: 10° C.), Mowinyl 742N (Tg: 37° C.), Mowinyl 749E (Tg: 25° C.), Mowinyl 752 (Tg: 16° C.), Mowinyl 916 (Tg: −5° C.), Mowinyl 1700A (Tg: 37° C.), Mowinyl 7210 (Tg: 16° C.), Mowinyl 747 (Tg: 42° C.), Mowinyl 6520 (Tg: 40° C.), Mowinyl 7502 (Tg: −35° C.), Mowinyl LDM7010 (Tg: 34° C.), Mowinyl VDM7410 (Tg: −4° C.), Mowinyl DM772 (Tg: 3° C.), Mowinyl DM774 (Tg: 10° C.), Mowinyl 947 (Tg: −55° C.), Mowinyl LDM6481 (Tg: −22° C.), Mowinyl LDM6880 (Tg: 9° C.), Mowinyl DM758 (Tg: −60° C.), Mowinyl DM765 (Tg: −19° C.), Mowinyl 650 (Tg: −37° C.), Mowinyl 760H (Tg: −17° C.), Mowinyl 761HG (Tg: −35° C.), Mowinyl 763 (Tg: −18° C.), Mowinyl 412 (Tg: −62° C.), Mowinyl 490 (Tg: −53° C.), Mowinyl S-71 (Tg: −53° C.), Mowinyl 987 (Tg: −2° C.), Mowinyl 1410 (Tg: −8° C.), Mowinyl 630 (Tg: 27° C.), Mowinyl 620 (Tg: −22° C.), Mowinyl 730L (Tg: −13° C.), Mowinyl 735 (Tg: 14° C.), Mowinyl 767 (Tg: 25° C.), Mowinyl 790 (Tg: 102° C.), Mowinyl 9000 (Tg: 46° C.), Mowinyl 880 (Tg: 3° C.), Mowinyl DM60 (Tg: 3° C.), Mowinyl 8020 (Tg: −22° C.), Mowinyl 8030 (Tg: 17° C.), Mowinyl 8055 (Tg: 78° C.), Mowinyl 8201 (Tg: 8° C.), Mowinyl 787 (Tg: 14° C.), Mowinyl 710 (Tg: 9° C.), Mowinyl 718 (Tg: −6° C.), Mowinyl 776 (Tg: −20° C.), Mowinyl 952 (Tg: −38° C.), Mowinyl 963A (Tg: −19° C.), Mowinyl DM772 (Tg: 6° C.), Mowinyl 975A (Tg: 27° C.), Mowinyl 3200 (Tg: −21° C.), Appretan 760H (Tg: −17° C.), Appretan 2200 (Tg: 19° C.), Appretan 2000 (Tg: 19° C.), Appretan 3510 (Tg: 0° C.), and Appretan 3410 (Tg: −32° C.) (foregoing trade names of Clariant Japan Inc.); PCL Series 0619 (Tg: −4° C.), PCL Series 0623A (Tg: −6° C.), PCL Series 0640 (Tg: 55° C.), PCL Series 0693 (Tg: 20° C.), PCL Series 0695 (Tg: −4° C.), PCL Series 0696 (Tg: −12° C.), PCL Series 0850 (Tg: 7° C.), PCL Series 0890 (Tg: −17° C.), PCL Series 0561 (Tg: −63° C.), SB Series 0589 (Tg: 0° C.), SB Series 0602 (Tg: 40° C.), SB Series 2108 (Tg: −66° C.), SB Series 0533 (Tg: −20° C., SB Series 0545 (Tg: −31° C.), SB Series 0548 (Tg: −49° C.), SB Series 0568 (Tg: −23° C.), SB Series 0569 (Tg: −4° C.), SB Series 0573 (Tg: −9° C.), SB Series 0597C (Tg: 28° C.), AE Series AE116 (Tg: 50° C.), AE Series AE119 (Tg: 55° C.), AE Series AE120 (Tg: −10° C.), AE Series AE121 (Tg: 58° C.), AE Series AE125 (Tg: 60° C.), AE Series AE134 (Tg: 48° C.), AE Series AE137 (Tg: 48° C.), AE Series AE140 (Tg: 53° C.), AE Series AE173 (Tg: 60° C.), AE Series AE200 (Tg: −45° C.), AE Series AE311 (Tg: −50° C.), AE Series AE318 (Tg: 5° C.), AE Series AE337 (Tg: −30° C.), AE Series AE343 (Tg: 0° C.), AE Series AE362 (Tg: −5° C.), AE Series AE373B (Tg: 10° C.), AE Series AE379A (Tg: 20° C.), AE Series AE513A (Tg: −48° C.), AE Series AE517 (Tg: −48° C.), AE Series AE604 (Tg: 5° C.), AE Series AE610C (Tg: −62° C.), AE Series AE815 (Tg: 5° C.), AE Series AE945 (Tg: −17° C.), AE Series AE950 (Tg: −20° C.), and AE Series AE986A (Tg: 2° C.) (foregoing trade names of JSR Corp.); Joncryl 7100 (Tg: −10° C.), Joncryl 390 (Tg: −5° C.), Joncryl 1674 (Tg: −4° C.),. Joncryl 711 (Tg: 0° C.), Joncryl 1695 (Tg: 5° C.), Joncryl 511 (Tg: 9° C.), Joncryl 7001 (Tg: 12° C.), Joncryl 632 (Tg: 12° C.), Joncryl 741 (Tg: 15° C.), Joncryl 450 (Tg: 16° C.), Joncryl 840 (Tg: 16° C.), Joncryl 74J (Tg: 22° C.), PDX-7111B (Tg: 19° C.), HRC-1645 (Tg: 21° C.), Joncryl 734 (Tg: 30° C.), Joncryl 852 (Tg: 31° C.), Joncryl 7600 (Tg: 35° C.), Joncryl 775 (Tg: 37° C.), Joncryl 537 (Tg: 49° C.), Joncryl 1535 (Tg: 50° C.), PDX-7630A (Tg: 53° C.), Joncryl 352 (Tg: 56° C.), Joncryl 352D (Tg: 56° C.), PDX-7145 (Tg: 56° C.), and Joncryl 538 (Tg: 66° C.) (foregoing trade names of Johnson Polymer Inc.).

In the aqueous ink composition of the invention, such resin emulsion may be employed by one kind or plural kinds, and, in at least a kind, the constituent resin component thereof preferably has a Tg equal to or higher than 30° C. This is because the resin emulsion, having a Tg of resin equal to or higher than 30° C., enables the dispersion substance, namely the colorant such as pigment, to be present in a larger amount on the surface of the recording medium, thereby providing an effect of improving the color developing property.

An amount of the resin emulsion may be suitably determined in consideration of the fixing property and the color developing property, but is preferably within a range of 0.1 to 20 wt. % in solid, in the aqueous ink composition. An amount of the resin emulsion less than 0.1 wt. % may result in an insufficient color developing property for the image. On the other hand, an amount exceeding 20 wt. % increases the viscosity of the ink, resulting drawbacks such as becoming unsuitable for the ink jet recording method and facilitating a nozzle clogging of the recording head because of a high solid concentration of the ink.

Weakly Alkalizing Agent

In case an ink jet recording apparatus uses a metal in a flow path for the aqueous ink composition, an acidic aqueous ink composition may cause a metal erosion. Therefore the aqueous ink composition of the invention is preferably regulated to a neutral or alkaline state.

For such regulation to neutral or alkaline state, the aqueous ink composition preferably further contains, in another embodiment, a weakly alkalizing agent. A strong alkaline compound such as sodium hydroxide, when employed for regulating the aqueous ink composition to a neutral or alkaline state, may induce a neutralization of acid groups, when the unneutralized group, constituting the hydrophobic part in the dispersing polymer, is an acid group (such as a carboxylic acid group or a sulfonic acid group). In such case, as explained before, the dispersing polymer becomes entirely water-soluble in extreme case, whereby the liberated polymer not adsorbed on the colorant such as pigment increases thereby resulting in drawbacks such as an unstable ejection of the aqueous ink composition from the recording head, and blurring and strike through on the image. In the present invention, a weakly alkalizing agent is employed to maintain the aqueous ink composition in a neutral or alkaline state without significantly affecting the neutralization rate of the dispersing polymer, thereby providing an aqueous ink composition of a higher reliability.

The weakly alkalizing agent can be a compound selected from an organic acid salt and an organic buffer. The organic acid salt is preferably a salt of an alkylcarboxylic acid such as an acetic acid salt or a propionic acid salt, or a salt of a hydroxy acid such as a lactic acid salt, a glycolic acid salt, or a glyceric acid salt. Among these, an alkali metal salt of an alkylcarboxylic acid is more preferable, such as sodium acetate, potassium acetate, sodium propionate or potassium propionate. The organic buffer is preferably tris(hydroxymethyl)aminomethane, a trishydrochlorate salt, trismaleic acid or bis(2-hydroxyethyl)iminotris(hydroxymethyl)methane.

An amount of the weakly alkalizing agent can be suitably selected according to a desired pH of the ink, and is preferably within a rangte of 0.01-10 wt. %.

Other Components

The aqueous ink composition of the invention may further include, if necessary, other additives ordinarily employing in an ink jet recording ink.

The additives added according to the necessity include an antioxidant, an ultraviolet absorber, an antiseptic, an antimold agent and a surfactant.

The antioxidant and the ultraviolet absorber can be, for example, an alohanate such as alohanate or methyl alohanate; a biuret such as buiret, dimethylbiuret or tetramethylbuiret; L-ascorbic acid or a salt thereof; Tinuvin 328, 900, 1130, 384, 292, 123, 144, 622, 770, or 292, Irgacor 252, or 153, Irganox 1010, 1076, 1035 or MD1024 manufactured by Ciba-Geigy Ltd.; or an oxide such as a lanthanide.

The antiseptic or antimold agent can be selected for example from sodium benzoate, sodium pentachlorophenol, sodium 2-pyridinethiol-1-oxide, sodium sorbate, sodium dehydroacetate and 1,2-dibenzylthiazolin-3-one.

The surfactant is an additive for further promoting the ink penetration into the recording medium, and there can be advantageously employed an anionic surfactant such as a fatty acid salt or an alkylsulfuric acid salt; a nonionic surfactant such as polyoxyethylene alkyl ether or polyoxyethylene phenyl ether; a silicon-based surfactant, a phosphor-based surfactant, or a boron-based surfactant according to the necessity.

Examples of the silicon-based surfactant include BYK-307, BYK-331, BYK-333 and BYK-348 (trade names of BYK Chemie AG).

<Physical Properties of Aqueous Ink Composition>

For the purposes of securing the storage stability (against changes in particle size or viscosity) and the dispersion stability and of preventing an erosion of metal parts that may be employed in a flow path of the aqueous ink composition in an ink jet recording apparatus, the aqueous ink composition of the invention preferably has a pH value regulated to a neutral or alkaline state. More preferably, the aqueous ink composition has a pH within a range of 7.0-10.0 at 25° C. Outside this range, drawbacks tend to appear in the storage stability, dispersion stability and erosion. In particular, at a pH exceeding 10.0, the dispersing polymer which encloses the colorant such as a pigment for constituting the dispersion substance becomes water-soluble and functions as a penetrating agent, thereby causing an excessive penetration into the recording medium and resulting in drawbacks of generating blurring and strike through in the image and deteriorating the color developing property.

Also for the purpose of securing the ejection stability in the ink jet recording apparatus, the aqueous ink composition of the invention preferably has a viscosity of 25 cPs or less at 25° C., more preferably 15 cPs or less.

<Dispersing Method for Colorant>

In the invention, the colorant can be dispersed with the dispersing polymer by a method of dissolving or dispersing a polymer containing an anionic group in alkaline water containing an alkaline compound such as an organic amine or an alkali metal salt, then mixing the obtained liquid with a colorant and executing a dispersion with a disperser such as a ball mill, a sand mill, an attritor, a roll mill, an agitator mill, a Henshell mixer, a colloid mill, an ultrasonic homogenizer, a jet mill or an Ong mill. More preferably, for stabilizing the dispersion by a firmer adhesion of the colorant and the dispersing polymer, a method disclosed in JP-A-9-151342, JP-A-10-140065, JP-A-11-209672, JP-A-11-172180, JP-A-10-25440, JP-A-11-43636 or JP-A-2001-247810 may be adopted for manufacture. In the following, methods disclosed in these patent literatures will be explained briefly.

JP-A-2001-247810, JP-A-9-151342 and JP-A-10-140065 disclose “a phase inversion method” and “an acid-precipitation method”.

a) “Phase Inversion Method”

In the present invention, a “phase inversion method” basically means a self-dispersion (phase inversion emulsification) method of dispersing a fused mixture of a polymer having a self-dispersing ability or a dissolving ability and a pigment into water. The fused mixture means a mixed state without dissolving or a mixed state with dissolving, or a state containing both.

As a specific example, the method includes:

(1) a step of adding a pigment, a neutralizer and a small amount of water to a solution of a dispersing polymer precursor (such as the aforementioned polymer including the anionic group) in a solvent, thereby preparing a solvent-based slurry;

(2) a step of dispersing the slurry into a large amount of water, thereby preparing a water-based slurry; and

(3) a step of removing the solvent employed for dissolving the polymer, from the water-based slurry, thereby preparing a dispersion substance of pigment-containing polymer particles, in which the pigment is enclosed with the water-dispersible polymer.

b) “Acid-precipitation” method

In the present invention, the “acid-precipitation” method means a method of preparing a water-containing cake constituted of a polymer and a pigment, and neutralizing, with a neutralizer, a part of the unneutralized groups present in the polymer contained in the water-containing cake, thereby preparing a colored material.

In case the unneutralized group is an anionic acid group and the neutralizer is a basic compound, the method specifically includes, for example:

(1) a step of dispersing a polymer and a pigment in an alkaline aqueous medium, with a heating process if necessary, to achieve gelation of the resin;

(2) a step of regulating pH to neutral or acidic to render the polymer hydrophobic, thereby firmly fixing the polymer to the pigment;

(3) a step of executing a filtration and a rinsing with water, if necessary, to obtain a water-containing cake;

(4) a step of neutralizing, with a basic compound, all or a part of the anionic groups present in the polymer contained in the water-containing cake, and then executing a re-dispersion in an aqueous medium; and

(5) a step of executing a heating process if necessary, to achieve gelation of the polymer.

The more specific producing processes by the “phase inversion” method and the “acid-precipitation” method may be same as those disclosed in JP-A-9-151342 and JP-A-10-140065.

Also JP-A-11-209672 and JP-A-11-172180 disclose producing methods for a colored substance, basically including following manufacturing steps:

(1) a step of mixing a polymer having an anionic group or a solution thereof in a solvent with a basic compound to perform a neutralization;

(2) a step of mixing the mixed liquid with a pigment to obtain a suspension and dispersing the pigment with a disperser to obtain a pigment dispersion;

(3) a step of removing the solvent if necessary;

(4) a step of adding an acidic compound to precipitate out the polymer thereby covering the pigment with the polymer having the anionic group;

(5) a step of executing a filtration and a rinsing with water, if necessary; and

(6) a step of adding a basic compound to neutralize a part of the anionic groups in the polymer having the anionic group, and executing a dispersion in an aqueous medium to obtain an aqueous dispersion.

Also the process may be same as those disclosed in JP-A-11-2-96722 and JP-A-11-172180.

The aqueous ink composition of the invention can be advantageously prepared by adding, to the aqueous dispersion of the colored material obtained as described above, the acetylene glycol-based surfactant, the urea derivative, and water as explained above, and also if necessary the humectant, penetrating solvent, resin emulsion, weakly alkalizing agent and other components.

<Ink Jet Recording Method and Recorded Matter>

The ink jet recording method of the invention may adopt any method capable of ejecting the above-described aqueous ink composition as a liquid droplet from a fine nozzle and depositing the liquid droplet onto a recording medium. Some of such method will be explained in the following. A first method is an electrostatic suction method of applying a strong electric field between a nozzle and an accelerating electrode positioned in front of the nozzle, and achieving recording either by a method of ejecting the ink continuously in droplets from the nozzle and giving a recording information signal to deflecting electrodes while the ink droplet flies therebetween, or a method of ejecting the ink droplets without deflection and corresponding to the recording information signal.

A second method applies a pressure to the ink by a small pump and mechanically vibrates the nozzle with a crystal oscillator or the like thereby forcedly ejecting ink droplets. The ejected ink droplet is charged simultaneous with the ejection, and the recording is achieved by giving a recording information signal to deflecting electrodes while the ink droplet flies therebetween.

A third method utilizes a piezoelectric element, which applies a pressure and a recording information signal simultaneously to the ink, thereby ejecting an ink droplet to achieve recording.

A fourth method utilizes a rapid expansion of the ink by thermal energy, in which the ink is heated to generate a bubble by a small electrode according to the recording information signal, thereby ejecting an ink droplet to achieve recording.

Among such various ink jet recording methods, the aqueous ink composition of the invention is preferably combined with a recording method of a relatively low ink ejection speed of 10 m/s or less to achieve a stable ink jet recording while preventing an ink deposition on the ejection nozzle.

Also recorded matter of the present invention is obtained by recording with the above-described aqueous ink composition by an ink jet recording method.

### EXAMPLES

The present invention will be illustrated in greater detail with reference to the following Examples, but the invention should not be construed as being limited thereto. Dispersions to be employed in the aqueous ink compositions of the invention were prepared in the following manner.

<Preparation of Dispersion>

(1) Dispersion 1

−75 g of carbon black (trade name: MA100, manufactured by Mitsubishi Chemical Corp.), 25 g of a styrene-acrylic acid dispersing polymer having a carboxylic acid group as an anionic group (trade name: Joncryl 611, manufactured by Johnson Polymer Inc., weight-average molecular weight: 8,100, acid value: 53 KOHmg/g), 0.75 g of potassium hydroxide and 250 g of deionized water prepared by an ion exchange and a reverse osmosis were mixed and dispersed for 10 hours in a ball mill using zirconia beads. The obtained crude dispersion was filtered with a Membrane Filter of a pore size of about 8 μm (trade name, manufactured by Nippon Millipore Ltd.) to eliminate coarse particles and diluted with deionized water to a pigment concentration of 15 wt. % to obtain a dispersion 1, dispersed with the dispersing polymer.

(2) Dispersion 2

A dispersion was prepared in the same manner as the dispersion 1, except that carbon black was replaced by Color Black S160 (trade name, manufactured by Degussa Corp. and the amount of potassium hydroxide was changed to 0.78 g, thus obtaining a dispersion 2.

(3) Dispersion 3

A dispersion was prepared in the same manner as the dispersion 1, except that carbon black was replaced by 65 g of an organic pigment C.I. Pigment Blue 15:3, the amount of the dispersing polymer was changed to 35 g and the amount of potassium hydroxide was changed to 100 g, thus obtaining a dispersion 3.

(4) Dispersion 4

A dispersion was prepared in the same manner as the dispersion 1, except that carbon black was replaced by an organic pigment C.I. Pigment Yellow 74, thus obtaining a dispersion 4.

(5) Dispersion 5

−75 g of carbon black (trade name: MA100, manufactured by Mitsubishi Chemical Corp.), 25 g of a styrene-acrylic acid dispersing polymer having a carboxylic acid group as an anionic group (trade name: Joncryl 678, manufactured by Johnson Polymer Inc., weight-average molecular weight: 8,500, acid value: 215 KOHmg/g), 1.80 g of potassium hydroxide and 250 g of deionized water prepared by an ion exchange and a reverse osmosis were mixed and dispersed for 10 hours in a ball mill using zirconia beads. The obtained crude dispersion was filtered with a Membrane Filter of a pore size of about 8 μm (trade name, manufactured by Nippon Millipore Ltd.) to eliminate coarse particles and diluted with deionized water to a pigment concentration of 15 wt. % to obtain a dispersion 5, dispersed with the dispersing polymer.

(6) Dispersion 6

A dispersion was prepared in the same manner as the dispersion 1, except that carbon black was replaced by Color Black S160 (trade name, manufactured by Degussa Corp. and the amount of potassium hydroxide was changed to 3.20 g, thus obtaining a dispersion 6.

(7) Dispersion 7

A dispersion was prepared in the same manner as the dispersion 5, except that carbon black was replaced by 80 g of an organic pigment C.I. Pigment Red 122, the amount of the dispersing polymer was changed to 20 g and the amount of potassium hydroxide was changed to 1.72 g, thus obtaining a dispersion 7.

(8) Dispersion 8

Synthesis of Dispersing Polymer

After the interior of a reaction vessel equipped with an agitator, a thermometer, a reflux tube and a dropping funnel was replaced with nitrogen, 25 g of styrene, 30 g of n-dodecyl methacrylate, 20 g of methoxypolyethylene glycol methacrylate, 15.5 g of butyl methacrylate and 9.3 g of methacrylic acid were dissolved in 100 g of methyl ethyl ketone and subjected to a nitrogen replacement.

A same solution was charged in the dropping funnel, and 0.2 g of 2,2′-azobis(2,4-isomethylvaleronitrile) were added and the mixture was subjected to a nitrogen replacement.

A polymerization reaction was conducted in a nitrogen atmosphere, under heating at 65° C. and under an addition of the solution of the dropping funnel over 3 hours. The obtained copolymer solution was purified by repeating drying under a reduced pressure, dissolution in methyl ethyl ketone and filtration, and was then diluted with methyl ethyl ketone so as to obtain a solid content of the dispersing polymer of 50 wt. %, thereby obtaining a solution A of a dispersing polymer with an acid value of about 70 KOHmg/g and a weight-average molecular weight of 50,000.

Preparation of Dispersion

150 g of carbon black (trade name: MA100, manufactured by Mitsubishi Chemical Corp.) and 100 g of the dispersing polymer solution A were mixed and agitated to obtain a slurry. The slurry was added with 20 g of a 10 wt. % aqueous solution of potassium hydroxide and subjected to a dispersion by an ultra high-pressure homogenizer.

Then the dispersion was gradually added to 400 g of purified water under agitation, then all methyl ethyl ketone and a part of water were removed at 60° C. under a reduced pressure, and deionized water was so added as to obtain a pigment concentration of 15 wt. % thereby obtaining a dispersion 8.

(9) Dispersion 9

A dispersion was prepared in the same manner as the dispersion 8, except that carbon black was replaced by Color Black S160 (trade name, manufactured by Degussa Corp. and the amount of the 10 wt. % aqueous solution of potassium hydroxide was changed to 16 g, thus obtaining a dispersion 9.

(10) Dispersion 10

−50 g of an organic pigment C.I. Pigment Blue 15:4 and 100 g of the dispersing polymer solution A were mixed and agitated to obtain a slurry. The slurry was added with 21 g of a 10 wt. % aqueous solution of potassium hydroxide and subjected to a dispersion by an ultra high-pressure homogenizer.

Then the dispersion was gradually added to 250 g of purified water under agitation, then all methyl ethyl ketone and a part of water were removed at 60° C. under a reduced pressure, and deionized water was so added as to obtain a pigment concentration of 15 wt. %, thereby obtaining a dispersion 10.

(11) Dispersion 11

A dispersion was prepared in the same manner as the dispersion 10, except that pigment was replaced by 200 g of an organic pigment C.I. Pigment Red 209 and the amount of the 10 wt. % aqueous solution of potassium hydroxide was changed to 10 g, thus obtaining a dispersion 11.

(12) Dispersion 12

A dispersion was prepared in the same manner as the dispersion 10, except that pigment was replaced by 150 g of an organic pigment C.I. Pigment Yellow 128 and the amount of the 10 wt. % aqueous solution of potassium hydroxide was changed to 10 g, thus obtaining a dispersion 12.

(13) Dispersion 13

Synthesis of Dispersing Polymer

In a 1L beaker, n-butyl methacrylate by 40 wt. %, n-butyl acrylate by 5 wt. %, styrene by 20 wt. %, 2-hydroxyethyl methacrylate by 15 wt. % and methacrylic acid by 20 wt. % were so mixed as to obtain a total amount of 500 g, and 4 g of tert-butyl peroxyoctoate as a polymerization initiator were added to obtain a mixture for polymer synthesis.

Then 500 g of methyl ethyl ketone were charged in a 1L flask, and heated to 75° C. under agitation in a nitrogen atmosphere. Under agitation at 75° C., the mixture for polymer synthesis was dropwise added over 3 hours. Then the reaction was continued for 8 hours under agitation at 75° C. Then the reaction product, after spontaneous cooling to 25° C., was diluted with methyl ethyl ketone to a solid content of 50 wt. % to obtain a solution B of a dispersing polymer with an acid value of 150 KOHmg/g and a weight-average molecular weight of 15,000.

Preparation of Dispersion

150 g of carbon black (trade name: MA100, manufactured by Mitsubishi Chemical Corp.), 100 g of the dispersing polymer solution B, 50 g of a 10 wt. % aqueous solution of potassium hydroxide and 700 g of deionized water purified by an ion exchange and a reverse osmosis were mixed and dispersed for 2 hours in a sand mill (manufactured by Yasukawa Seisakusho Co.) together with glass beads (diameter: 1.7 mm, 1.5 times amount (weight) of the mixture). Then the glass beads were removed, and, after an addition of other components and an agitation for 20 minutes at the normal temperature, the mixture was filtered by a membrane filter of a pore size of 5 μm.

The obtained filtrate was distilled at 80° C. to remove all methyl ethyl ketone and a part of water. Then a 1N hydrochloric acid solution was dropewise added under agitation to cause coagulation of the dispersing polymer layer. It was suction filtered under rinsing with water to obtain a water-containing pigment cake. The water-containing cake was re-dispersed in 375 g of a 1 wt. % aqueous solution of potassium hydroxide under agitation, then deionized water was so added to obtain a pigment concentration of 15 wt. % thereby obtaining a dispersion 13.

(14) Dispersion 14

A dispersion was prepared in the same manner as the dispersion 13, except that carbon black was replaced by Color Black S160 (trade name, manufactured by Degussa Corp. and the amount of the 1 wt. % aqueous solution of potassium hydroxide at the re-dispersion was changed to 422 g, thus obtaining a dispersion 14.

(15) Dispersion 15

A dispersion was prepared in the same manner as the dispersion 13, except that carbon black was replaced by 250 g of an organic pigment C.I. Pigment Violet 19 and the amount of the 1 wt. % aqueous solution of potassium hydroxide at the re-dispersion was changed to 422 g, thus obtaining a dispersion 15.

(16) Dispersion 16

Preparation of Dispersing Polymer

50 g of a styrene-methyl methacrylate copolymer with a weight-average molecular weight of 15,000 and a styrene molar ratio of 35%, 500 g of 2-pyrrolidone, and 25 g of sulfamic acid were mixed, then reacted for 3 hours at 80° C. to sulfonate a part of styrene, then purified by repeating dissolution in 2-pyrrolidone and precipitation with acidic water of pH 5.0, and was dissolved in methyl ethyl ketone so as to obtain a solid content of 50 wt. %, thereby obtaining a solution C of a dispersing polymer with an acid value of 70 KOHmg/g and a weight-average molecular weight of 15,000.

Preparation of Dispersion

150 g of carbon black (trade name: MA100, manufactured by Mitsubishi Chemical Corp.), 100 g of the dispersing polymer solution C, 25 g of a 10 wt. % aqueous solution of potassium hydroxide and 700 g of deionized water purified by an ion exchange and a reverse osmosis were mixed and dispersed for 2 hours in a sand mill (manufactured by Yasukawa Seisakusho Co.) together with glass beads (diameter: 1.7 mm, 1.5 times amount (weight) of the mixture). Then the glass beads were removed, and, after an addition of other components and an agitation for 20 minutes at the normal temperature, the mixture was filtered by a membrane filter of a pore size of 5 μm.

The obtained filtrate was distilled at 80° C. to remove all methyl ethyl ketone and a part of water. Then a 1N hydrochloric acid solution was dropewise added under agitation to cause coagulation of the dispersing polymer layer. It was suction filtered under rinsing with water to obtain a water-containing pigment cake. The water-containing cake was re-dispersed in 70 g of a 1 wt. % aqueous solution of potassium hydroxide under agitation, then deionized water was so added to obtain a pigment concentration of 15 wt. % thereby obtaining a dispersion 16.

(17) Dispersion 17

A dispersion was prepared in the same manner as the dispersion 16, except that carbon black was replaced by 250 g of an organic pigment C.I. Pigment Blue 60, thus obtaining a dispersion 17.

<Preparation of Aqueous Ink Composition>

### Example 1

In Example 1, 26.7 g of the dispersion 1 (using carbon black) obtained in the above-described method, 10.0 g of 1,2-dimethylurea and 10.0 g of N-methylurea as the urea derivatives, 0.5 g of Surfynol 104 as the acetylene glycol-based surfactant, and deionized water to make a total amount of 100 g were agitated for 2 hours and filtered through a Membrane Filter of a pore size of 1.2 μm (trade name, manufactured by Nippon Millipore Ltd.) to obtain an aqueous ink composition.

### Examples 2 to 17

Ink compositions were prepared in the same manner as in Example 1, except that the additives and the amounts were changed as shown in Tables 1 and 2.

### Comparative Example 1

An aqueous ink composition was prepared with the same composition as in Example 1, except that 1,3-dimethylurea and N-methylurea as the urea derivatives were not added and correspondingly replenished by deionized water.

### Comparative Example 2

An aqueous ink composition was prepared with the same composition as in Example 1, except that 4.0 g of 1 wt. % aqueous solution of potassium hydroxide were added. As a result of addition of potassium hydroxide at the preparation of the aqueous ink composition, potassium hydroxide assumed a molar ratio of 130% with respect to the entire carboxylic acid groups in the dispersing polymer, whereby all the carboxylic acid groups were changed to a state of potassium salt of carboxylic acid.

### Comparative Example 3

An aqueous ink composition was prepared with the same composition as in Example 1, except that Surfynol 104 as the acetylene glycol-based surfactant was not added and correspondingly replenished by deionized water.

### Comparative Example 4

An aqueous ink composition was prepared with the same composition as in Example 1, except that Surfynol 104 as the acetylene glycol-based surfactant was not added and replaced by Emulgen 123P (trade name, polyoxyethylene-based surfactant manufactured by Kao Corp.).

The formulations explained above are summarized in Tables 1 and 2.

TABLE 1

| | Example | | | | | | |
|---|---|---|---|---|---|---|---|
| Composition | 1 | 2 | 3 | 4 | 5 | 6 | 7 |
| dispersion used | 1 | 2 | 3 | 4 | 5 | 6 | 7 |
| amount of dispersion (wt %) | 26.7 | 53.3 | 26.7 | 40.0 | 26.7 | 46.7 | 40.0 |
| additive/amount (wt %) | | | | | | | |
| 1,3-dimethylurea | 10.0 | 5.0 | — | — | 3.0 | 1.0 | — |
| N-methylurea | 10.0 | — | 3.0 | — | — | 1.0 | 2.0 |
| maronylurea | — | 5.0 | 2.0 | — | 5.0 | — | 3.0 |
| creatinine | — | — | — | 15.0 | — | — | — |
| 2-imidazolidinethion | — | — | — | 5.0 | — | — | — |
| Surfynol 465 | — | 2.0 | — | 1.0 | — | 0.5 | — |
| Surfynol TG | — | — | 1.0 | — | 0.5 | 0.1 | — |
| Surfynol 104 | 0.5 | — | — | 0.5 | 0.1 | 0.1 | 0.01 |
| Emulgen 123P | — | — | — | — | — | — | — |
| glycerin | — | 10.0 | — | 1.0 | — | — | — |
| diethylene glycol | — | — | — | — | — | — | — |
| triethylene glycol | — | 3.0 | — | — | — | — | — |
| trimethylolpropane | — | — | — | — | — | 5.0 | — |
| 2-pyrrolidone | — | — | — | — | — | — | — |
| iso-propyl alcohol | — | — | — | 3.0 | — | — | 1.0 |
| triethylene glycol monobutyl ether | — | — | 5.0 | — | — | — | 3.0 |
| 1,2-hexanediol | — | — | 1.0 | — | — | — | 1.0 |
| 2-butanol | — | — | — | 2.0 | — | — | — |
| Mowinyl 742N: 37° C., 43% | — | — | — | — | 3.0 | — | — |
| AE series AE343: 0° C., 55% | — | — | — | — | — | 2.0 | — |
| Joncryl 538: 66° C., 45% | — | — | — | — | — | — | 5.0 |
| potassium propionate | — | — | — | — | — | — | — |
| tris(hydroxymethyl)aminomethane | — | — | — | — | — | — | — |
| 1% potassium hydroxide solution | — | — | — | — | — | — | — |
| deionized water | remainder | remainder | remainder | remainder | remainder | remainder | remainder |

Example

| Composition | 8 | 9 | 10 | 11 | 12 |
|---|---|---|---|---|---|
| dispersion used | 8 | 9 | 10 | 11 | 12 |
| amount of dispersion (wt %) | 26.7 | 53.3 | 26.7 | 40.0 | 40.0 |
| additive/amount (wt %) | | | | | |
| 1,3-dimethylurea | — | — | — | — | 3.0 |
| N-methylurea | — | — | — | — | 2.0 |
| maronylurea | 1.0 | — | — | 1.0 | — |
| creatinine | 1.0 | 0.1 | 2.0 | — | 1.0 |
| 2-imidazolidinethion | — | — | 2.0 | 1.0 | — |
| Surfynol 465 | — | 10.0 | — | 1.0 | 0.5 |
| Surfynol TG | 0.1 | — | — | 0.5 | 0.1 |
| Surfynol 104 | — | — | 0.3 | — | 0.1 |
| Emulgen 123P | — | — | — | — | — |
| glycerin | 3.0 | 15.0 | — | — | — |
| diethylene glycol | 1.0 | 3.0 | — | 3.0 | — |
| triethylene glycol | — | — | — | 5.0 | — |
| trimethylolpropane | 2.0 | 2.0 | — | 2.0 | — |
| 2-pyrrolidone | 1.0 | 3.0 | — | — | — |
| iso-propyl alcohol | — | 3.0 | — | — | — |
| triethylene glycol monobutyl ether | 3.0 | 1.0 | — | — | — |
| 1,2-hexanediol | — | — | — | — | 5.0 |
| 2-butanol | 2.0 | 1.0 | — | — | — |
| Mowinyl 742N: 37° C., 43% | 1.5 | — | — | — | — |
| AE series AE343: 0° C., 55% | 1.5 | 2.5 | — | — | — |
| Joncryl 538: 66° C., 45% | — | 1.0 | — | — | — |
| potassium propionate | — | — | — | 0.5 | 0.1 |
| tris(hydroxymethyl)aminomethane | — | — | 2.0 | — | 0.1 |
| 1% potassium hydroxide solution | — | — | — | — | — |
| deionized water | remainder | remainder | remainder | remainder | remainder |

TABLE 2

| | Example | | | | | Comparative Example | | | |
|---|---|---|---|---|---|---|---|---|---|
| Composition | 13 | 14 | 15 | 16 | 17 | 1 | 2 | 3 | 4 |
| dispersion used | 13 | 14 | 15 | 16 | 17 | 1 | 1 | 1 | 1 |
| amount of dispersion (wt %) | 26.7 | 53.3 | 40.0 | 26.7 | 40.0 | 26.7 | 26.7 | 26.7 | 26.7 |
| additive/amount (wt %) | | | | | | | | | |
| 1,3-dimethylurea | 1.0 | 5.0 | — | 20.0 | 0.1 | — | 10.0 | 10.0 | 10.0 |
| N-methylurea | — | — | 0.1 | — | — | — | 10.0 | 10.0 | 10.0 |
| maronylurea | 1.0 | — | 0.1 | — | — | — | — | — | — |
| creatinine | — | — | 0.1 | — | — | — | — | — | — |
| 2-imidazolidinethion | 2.0 | — | — | — | — | — | — | — | — |
| Surfynol 465 | — | — | 0.1 | — | — | — | — | — | — |
| Surfynol TG | 1.0 | — | — | — | — | — | — | — | — |
| Surfynol 104 | — | 2.5 | 0.1 | 5.0 | 0.05 | 0.5 | 0.5 | — | — |
| Emulgen 123P | — | — | — | — | — | — | — | — | 0.5 |
| glycerin | 5.0 | 5.0 | — | 1.0 | — | — | — | — | — |
| diethylene glycol | 1.0 | — | — | — | — | — | — | — | — |
| triethylene glycol | 1.0 | — | — | 2.0 | — | — | — | — | — |
| trimethylolpropane | 2.0 | 10.0 | 10.0 | 15.0 | 1.0 | — | — | — | — |
| 2-pyrrolidone | 1.0 | 2.0 | 5.0 | 10.0 | — | — | — | — | — |
| iso-propyl alcohol | 5.0 | 3.0 | — | — | — | — | — | — | — |
| triethylene glycol monobutyl ether | — | 2.0 | — | — | 0.5 | — | — | — | — |
| 1,2-hexanediol | — | — | 3.0 | — | 0.25 | — | — | — | — |
| 2-butanol | — | — | 5.0 | 10.0 | 0.5 | — | — | — | — |
| Mowinyl 742N: 37° C., 43% | — | 5.0 | 5.0 | 5.0 | 0.1 | — | — | — | — |
| AE series AE343: 0° C., 55% | — | — | 10.0 | — | — | — | — | — | — |
| Joncryl 538: 66° C., 45% | — | — | 5.0 | 5.0 | — | — | — | — | — |
| potassium propionate | — | — | 5.0 | — | 0.1 | — | — | — | — |
| tris(hydroxymethyl)aminomethane | 0.01 | 5.0 | 5.0 | 10.0 | 0.1 | — | — | — | — |
| 1% potassium hydroxide solution | — | — | — | — | — | — | 4.0 | — | — |
| deionized water | remainder | remainder | remainder | remainder | remainder | remainder | remainder | remainder | remainder |

<Evaluation Method>
Storage Stability

Each of the aqueous ink compositions of Examples 1-17 and Comparative Examples 1-4 was let to stand for 2 weeks or for 1 month at 60° C., or for 1 week in a frozen state, and changes in the viscosity and the particle size were compared between immediately after manufacture and after standing. Criteria for evaluation were as follows:

Viscosity

rank AA: change less than ±3%

A: change of ±3% or larger but less than ±6%
B: change of ±6% or larger but less than ±10%
C: change of ±10% or larger.

particle size

rank AA: change less than ±5%
A: change of ±5% or larger but less than ±10%
B: change of ±10% or larger but less than ±20%
C: change of ±20% or larger.
   Ejection Stability

Each of the aqueous ink compositions of Examples 1-17 and Comparative Examples 1-4 was loaded in an ink jet printer Epson Stylus C82 (trade name, manufactured by Seiko-Epson Co.), and was used to continuously record, on an A4-sized recording paper Xerox P (trade name, manufactured by Fuji-Xerox Office Supply Co.), an image containing characters and solid areas under an environment of 20-25° C./40-60% RH, and presence/absence of defects such as a flight deflection and a dot missing in the recorded image by a visual observation. Criteria for evaluation were as follows:

rank AA: no flight deflection/dot missing in continuous recording up to 200 sheets

A: no flight deflection/dot missing in continuous recording up to 100 sheets

B: flight deflection/dot missing present but less than in 10 locations, in continuous recording up to 100 sheets

C: flight deflection/dot missing present in 10 locations or more, in continuous recording up to 100 sheets.

Evaluation of Image Quality

Each of the aqueous ink compositions of Examples 1-17 and Comparative Examples 1-4 was loaded in an ink jet printer Epson Stylus C82 (trade name, manufactured by Seiko-Epson Co.). Under a print setting of “paper type: plain paper, print quality: fine” for a plain paper or a recycled paper and of “paper type: Glossy Photo Paper, print quality: photo” for a glossy medium, gothic characters of 1-20 points were printed for every point size, and an image quality (character quality) was evaluated by blurring of the character. Also under a similar print setting, a solid image with densities from 5 to 100% stepwise varied by every 5% was printed, and a print quality (solid image quality) was evaluated by a density unevenness and a strike through in the recorded matter. This evaluation was conducted on plain papers, Xerox Premium Multipurpose 4024 (trade name, manufactured by Xerox Corp., hereinafter represented as “Xerox 4024”) and Hammermill Copy Plus (trade name, manufactured by International Paper Co., hereinafter represented as “HCP”); a recycled paper, Xerox R (trade name, manufactured by Fuji-Xerox Office Supply Co.); and glossy media, Premium Glossy Photo Paper and DURABrite® Ink Glossy Photo Paper (trade names, manufactured by Seiko-Epson Co.), Professional Photo Paper (trade name, manufactured by Canon Inc., hereinafter represented as “PPP”), and Photo Glossy Thick QP20A4GH (trade name, manufactured by Konica Minolta Holdings, Inc.), and evaluation was executed by visual observation. Criteria for evaluation were as follows:

Character Quality:

rank AA: no blurring observable in characters of all point sizes

A: slight blurring observable in characters of 5 points or less

B: characters of 5 points or less appeared thicker because of blurring

C: characters of 5 points or less illegible because of significant blurring.

Solid Image Quality:

rank AA: scarce density unevenness in all solid images and no strike through

A: slight density unevenness in image of 100% solid density but practically permissible, and scarce strike through

B: density unevenness observable in images of solid density of 50% or higher, and strike through evident

C: density unevenness observable in all solid images, and low recording density because of significant strike through.

Evaluation of Gloss on Glossy Medium

Each of the aqueous ink compositions of Examples 1-17 and Comparative Examples 1-4 was loaded in an ink jet printer Epson Stylus C82 (trade name, manufactured by Seiko-Epson Co.). Under a print setting of “paper type: Glossy Photo Paper, print quality: photo” a solid image with densities from 5 to 100% stepwise varied by every 5% was printed, and a gloss of the printed matter was evaluated. The glossy media employed in this evaluation were same as those employed for the “evaluation of image quality”. The evaluation was executed by visual observation. Criteria for evaluation were as follows:

rank AA: gloss observable in all solid images

A: slight lack of gloss in image of 100% solid density but practically permissible

B: lack of gloss in images of solid density of 50% or higher

C: lack of gloss in all solid images.

Evaluation of Fixing Property of Recorded Matter

Each of the aqueous ink compositions of Examples 1-17 and Comparative Examples 1-4 was loaded in an ink jet printer Epson Stylus C82 (trade name, manufactured by Seiko-Epson Co.). Under a print setting of “paper type: plain paper, print quality: fine” for a plain paper or a recycled paper and of “paper type: Glossy Photo Paper, print quality: photo” for a glossy medium, gothic characters of 12 points were printed, and a fixing property of the recorded matter was evaluated. Plain/recycled paper and glossy media employed in this evaluation were same as those used in the “evaluation of image quality”. The evaluation was conducted on recorded matter, dried for 1 hour in the conditions of 20-25° C./40-60% RH after the printing, by visually observing a shifting/thinning of the character after a rubbing with a finger. Criteria for evaluation were as follows:

rank AA: no shifting/thinning observable

A: slight shifting observable but practically permissible

B: shifting or thinning observable

C: significant shifting/thinning, and characters not easily legible.

Tables 3 and 4 summarize, on each aqueous ink composition, the pH at 25° C. at preparation, storage stability (viscosity, particle size), ejection stability, image quality (character quality, solid image quality), gloss on glossy media and fixing property of recorded matter.

TABLE 3

| | | | Example | | | | | | | | | | | |
|---|---|---|---|---|---|---|---|---|---|---|---|---|---|---|
| evaluation item | | | 1 | 2 | 3 | 4 | 5 | 6 | 7 | 8 | 9 | 10 | 11 | 12 |
| pH of aq. ink composition (25° C.) | | | 8.8 | 8.5 | 8.7 | 8.5 | 8.2 | 8.0 | 8.5 | 8.1 | 9.1 | 9.2 | 9.0 | 9.3 |
| storage stability | | viscosity | A | A | A | A | A | A | AA | AA | AA | AA | A | A |
| | | particle size | A | A | AA | A | AA | A | A | AA | AA | A | AA | A |
| ejection stability | | | A | AA | A | AA | A | A | AA | AA | AA | AA | A | AA |
| recording | character | Xerox 4024 | A | AA | AA | AA | AA | A | AA | AA | A | A | AA | AA |
| quality | quality | HCP | A | A | AA | AA | A | A | AA | AA | A | A | AA | AA |
| | | Xerox R | A | A | AA | AA | A | A | AA | AA | A | A | A | AA |
| | | Premium Glossy Photo Paper | A | A | A | A | A | A | A | AA | AA | A | A | AA |
| | | DURABrite ® Ink Glossy Photo Paper | A | A | AA | AA | A | A | AA | AA | AA | A | AA | AA |
| | | PPP | A | A | A | A | A | A | A | A | AA | A | A | A |
| | | Photo Glossy Thick | A | A | A | A | A | A | A | AA | AA | A | A | A |
| | solid | Xerox 4024 | A | A | AA | AA | AA | A | AA | AA | A | AA | AA | AA |
| | image | HCP | A | A | A | A | AA | A | AA | AA | A | A | AA | AA |
| | quality | Xerox R | A | A | AA | AA | AA | A | AA | AA | A | A | A | AA |
| | | Premium Glossy Photo Paper | A | A | A | A | A | A | A | AA | AA | AA | AA | AA |
| | | DURABrite ® Ink Glossy Photo Paper | A | A | AA | AA | A | A | AA | AA | AA | AA | AA | AA |
| | | PPP | A | A | A | A | A | A | A | A | AA | A | A | A |
| | | Photo Glossy Thick | A | A | A | A | A | A | A | A | AA | A | AA | A |
| | gloss | Premium Glossy Photo Paper | A | A | A | A | A | A | A | AA | AA | A | A | AA |
| | | DURABrite ® Ink Glossy Photo Paper | AA | A | A | A | A | AA | A | AA | AA | AA | AA | AA |
| | | PPP | A | A | A | A | A | A | A | A | A | A | A | A |
| | | Photo Glossy Thick | A | A | A | A | A | A | A | A | AA | A | AA | A |

| | | | | | | | | | | | | | |
|---|---|---|---|---|---|---|---|---|---|---|---|---|---|
| fixing property | Xerox 4024 | AA | AA | AA | AA | AA | AA | AA | AA | AA | AA | AA | AA |
| | HCP | A | A | AA | AA | A | AA | AA | AA | AA | AA | AA | AA |
| | Xerox R | AA | AA | AA | AA | AA | AA | AA | AA | AA | AA | AA | AA |
| | Premium Glossy Photo Paper | A | A | A | A | A | A | A | AA | AA | A | A | AA |
| | DURABrite ® Ink Glossy Photo Paper | A | A | AA | AA | A | AA | A | AA | AA | AA | AA | AA |
| | PPP | A | A | A | A | A | A | A | A | A | A | A | A |
| | Photo Glossy Thick | A | A | A | A | A | AA | A | A | AA | A | AA | A |

TABLE 4

| | | | Example | | | | | Comparative Example | | | |
|---|---|---|---|---|---|---|---|---|---|---|---|
| evaluation item | | | 13 | 14 | 15 | 16 | 17 | 1 | 2 | 3 | 4 |
| pH of aq. ink composition (25° C.) | | | 8.6 | 9.1 | 9.8 | 9.2 | 8.0 | 8.0 | 10.5 | 8.5 | 8.1 |
| storage stability | | viscosity | AA | A | A | A | AA | AA | C | A | A |
| | | particle size | A | A | A | AA | AA | AA | C | A | B |
| ejection stability | | | AA | A | A | A | A | C | B | A | B |
| recording | character | Xerox 4024 | AA | AA | A | AA | AA | A | C | B | B |
| quality | quality | HCP | AA | AA | A | AA | AA | B | C | B | B |
| | | Xerox R | AA | AA | A | AA | AA | B | C | C | B |
| | | Premium Glossy Photo Paper | A | AA | AA | A | AA | B | C | C | B |
| | | DURABrite ® Ink Glossy Photo Paper | A | AA | AA | A | AA | A | C | C | C |
| | | PPP | A | AA | A | A | AA | C | C | C | C |
| | | Photo Glossy Thick | A | AA | A | A | AA | C | C | C | C |
| | solid | Xerox 4024 | AA | AA | AA | AA | A | B | C | C | B |
| | image | HCP | AA | AA | AA | AA | A | B | C | C | B |
| | quality | Xerox R | AA | AA | AA | AA | A | C | C | C | B |
| | | Premium Glossy Photo Paper | A | AA | AA | AA | A | C | B | C | B |
| | | DURABrite ® Ink Glossy Photo Paper | A | AA | AA | AA | A | C | C | C | C |
| | | PPP | A | AA | AA | AA | A | C | B | C | C |
| | | Photo Glossy Thick | A | AA | AA | AA | A | C | B | C | C |
| | gloss | Premium Glossy Photo Paper | A | AA | AA | A | A | C | A | C | B |
| | | DURABrite ® Ink Glossy Photo Paper | A | AA | AA | AA | A | C | A | B | B |
| | | PPP | A | AA | AA | A | A | C | A | C | C |
| | | Photo Glossy Thick | A | AA | AA | AA | A | C | A | C | C |

| | | | | | | | | | | |
|---|---|---|---|---|---|---|---|---|---|---|
| fixing property | Xerox 4024 | AA | AA | AA | AA | A | B | A | C | B |
| | HCP | AA | AA | AA | AA | A | B | A | C | B |
| | Xerox R | AA | AA | AA | AA | A | B | A | C | B |
| | Premium Glossy Photo Paper | A | AA | AA | AA | A | C | A | C | B |
| | DURABrite ® Ink Glossy Photo Paper | A | AA | AA | AA | A | C | A | C | C |
| | PPP | A | A | AA | A | A | C | A | C | C |
| | Photo Glossy Thick | A | AA | AA | A | A | C | B | C | C |

As shown in Tables 3 and 4, the aqueous ink compositions of Example 1-17 were satisfactory in the storage stability (changes in viscosity and particle size) when let to stand under the aforementioned conditions, and also in the ejection stability in the ink jet printer. Also the recording quality (character quality, solid image quality and gloss) and the gloss were satisfactory regardless of the type of the paper.

On the other hand, Comparative Example 1, formed without the urea derivative in Example 1, was inferior in the ejection stability on the ink jet printer, and was inferior also in the recording quality (character quality, solid image quality and gloss) and in the gloss.

Also Comparative Example 2, formed by adding potassium hydroxide to Example 1 thereby neutralizing all the unneutralized groups therein, showed a viscosity change from immediately after the blending of the materials of the aqueous ink composition, and was inferior in the storage stability when let to stand under the aforementioned conditions. Also in the ejection stability, because of the influence of addition of potassium hydroxide, the dispersing polymer was deposited on a nozzle face of the recording head, thus resulting in flight deflection and dot missing. Also in the recording quality, because of the influence of water-solubilized dispersing polymer, blurring was observed in the character quality, and a density unevenness and a strike through with a lowered print density were observed in the solid image quality.

Also Comparative Example 3, formed with the acetylene glycol-based surfactant in Example 1, was poor in the penetration property to the recording medium, showing blurring in the character quality and a density unevenness in the solid image quality. Also it was inferior in the gloss and the fixing property.

Also Comparative Example 4, employing a polyoxyethylene surfactant instead of the acetylene glycol-based surfactant in Example 1, showed a poor penetration property depending on recording media, and developed blurring in the character quality and a density unevenness in the solid image quality on certain recording media. It was also inferior in the gloss and the fixing property on certain recording media.

The present invention has been explained by specific embodiments, but it will be apparent to those skilled in the art, that the present invention is subject to various modifications and alterations without departing form the spirit and scope of the invention.

The aqueous ink composition of the present invention is satisfactory in the storage stability and the ejection stability, shows an excellent color developing property regardless of the type of the recording medium, and is therefore adapted for use as an ink for ink jet recording.

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-015461 filed Jan. 24, 2005, the contents thereof being herein incorporated by reference.

What is claimed is:

1. An aqueous ink composition comprising a coloring component, an acetylene glycol-based surfactant, water, and a urea derivative,
wherein the coloring component is a dispersion substance in which a colorant is enclosed with a dispersing polymer thereby being rendered dispersible in water,
wherein the dispersing polymer comprises a hydrophobic part and a hydrophilic part,
wherein at least a part of the hydrophilic part is a neutralized group obtained by neutralizing an unneutralized group constituting a part of the hydrophilic part, and
wherein the neutralized groups are present within an amount range of from 20% to less than 60% in terms of molar ratio based on the sum of the neutralized groups and the unneutralized groups.

2. The aqueous ink composition according to claim 1, further comprising a humectant.

3. The aqueous ink composition according to claim 1, further comprising a penetrating solvent.

4. The aqueous ink composition according to claim 3, wherein the penetrating solvent is selected from the group consisting of a monohydric alcohol, a glycol monoether derivative of a polyhydric alcohol, and a 1,2-alkyldiol.

5. The aqueous ink composition according to claim 1, further comprising a resin emulsion.

6. The aqueous ink composition according to claim 5, wherein the resin emulsion comprises at least a resin emulsion comprising a resin having a glass transition temperature (Tg) of 30° C. or higher.

7. The aqueous ink composition according to claim 1, wherein the colorant is carbon black.

8. The aqueous ink composition according to claim 1, wherein the colorant is an organic pigment.

9. The aqueous ink composition according to claim 1, further comprising a weakly alkalizing agent and being alkaline.

10. The aqueous ink composition according to claim 9, wherein the weakly alkalizing agent comprises at least a compound selected from an organic acid salt and an organic buffer.

11. An ink jet recording method which comprises ejecting a liquid droplet of an aqueous ink composition according to claim 1, and depositing the liquid droplet onto a recording medium to perform a recording.

12. Recorded matter obtained by ink jet recording with an aqueous ink composition according to claim 1.
